(19) United States
(12) Patent Application Publication
(10) Pub. No.: US 2010/0194225 A1
(43) Pub. Date: Aug. 5, 2010

(54) Self Sensing Integrated System and Method for Determining the Position of a Shaft in a Magnetic Bearing

(75) Inventors: Paul E. Allaire, Charlottesville, VA (US); Wei Jiang, Charlottesville, VA (US)

Correspondence Address: UNIVERSITY OF VIRGINIA PATENT FOUNDATION, 250 WEST MAIN STREET, SUITE 300, CHARLOTTESVILLE, VA, 22902, US

(73) Assignee: UNIVERSITY OF VIRGINIA PATENT FOUNDATION, Charlottesville, VA (US)

(21) Appl. No.: 12/668,753

(22) PCT Filed: Jul. 15, 2008
(86) PCT No.: PCT/US08/70073

§ 371 Date: Jan. 12, 2010

Related U.S. Application Data
(60) Provisional application No. 60/959,635, filed on Jul. 16, 2007.

(51) Int. Cl. H02K 7/09

(52) U.S. Cl. 310/90.5

(57) ABSTRACT

A magnetic bearing system and related method that utilizes self-sensing in order to determine and adjust the position of a shaft within the bearing. Magnetic bearings levitate a rotating object with a magnetic field and are unstable in open-loop operation. Position feedback control is required to maintain a rotor in a centered position. The system and related method uses a unique design to sense the position of the rotating object with greater accuracy. It comprises coils which are used both to detect and adjust the position of the rotating object and a control system which supplies signals in a time-multiplexed manner in order to determine the position with accuracy while still allowing the same coils that are used to detect position to also supply a field to control the position of the rotor.

### RELATED APPLICATIONS

This application claims benefit of Provisional Application Ser. No. 60/959,635 filed Jul. 16, 2007, entitled “Self Sensing Integrated System for Determining the Position of a Shaft in a Magnetic Bearing,” of which the disclosure is hereby incorporated by reference herein in its entirety.

### FIELD OF THE INVENTION

The present invention pertains to detecting the position of a target shaft in an active magnetic bearing (AMB) system without using a separate physical sensor.

### BACKGROUND OF THE INVENTION

Historically, there are two primary classes of self-sensing methods; 1) state estimation and 2) inductance (displacement) measurement from switching Pulse Width Modulation (PWM) amplifier waveforms. State estimation approaches model the bearing as a linear, time-invariant system and treat the rotor position as a state to be estimated as part of linear, time-invariant feedback control. PWM-based approaches rely on the effects of the driving switching amplifier to estimate position.

The PWM-based self-sensing method can be further divided into two categories: 2a) a current ripple-based approach in which the estimates of position are generated from the relationship between switching voltage and current signals, and 2b) a differential voltage based method in which the estimates of position are generated from the voltage difference between a coaxial pair of electromagnetic coils.

First we consider the first type of self-sensing—state estimation. Unfortunately, the state space estimate method has long been proven to have limited performance as indicated in many research articles. This is especially true for AMB system coils that are coupled with switching amplifiers. This method is not discussed further.

Now we consider the second type of self-sensing—PWM based methods. A previous invention, described in Chen '014 (U.S. Pat. No. 5,666,014, of which is hereby incorporated by reference herein in its entirety) allegedly describes a method using inexpensive and rugged search coils as sensors instead of costly and delicate displacement or position sensors in the magnetic bearing. As noted in Chen '014, this method is only able to estimate velocity, which limits its effectiveness for most magnetic bearing applications which require position sensing rather than velocity sensing. Additionally, it does not work well with commonly used switching amplifiers for magnetic bearings.

Moriyama '388 (U.S. Pat. No. 6,515,388 of which is hereby incorporated by reference herein in its entirety) allegedly describes a magnetic control levitation apparatus which contains a self-sensing method using signal injection and synchronizing demodulation by a DSP processor. It is based upon the switching current ripple with a signal injection of a predefined pattern. Other patents Khanwilkar '180 (U.S. Pat. No. 6,074,180 of which is hereby incorporated by reference herein in its entirety), Khanwilkar '661 (U.S. Pat. No. 6,302,661 of which is hereby incorporated by reference herein in its entirety), Khanwilkar '762 (U.S. Pat. No. 6,595,762 of which is hereby incorporated by reference herein in its entirety), and Olsen '398 (U.S. Pat. No. 7,070,398 of which is hereby incorporated by reference herein in its entirety) allegedly describe self-sensing systems which are intended for use in centrifugal pumps supported in AMBs with the associate self-sensing method based on the current ripple method. This method uses the PWM switching signal from the power amplifiers as an injecting signal and measures the shaft displacement from the current ripple pattern with special types of filters. However, the major problem for the current ripple-based approach is that the current signal is noisy due to the switching amplifiers.

The prior patents Ianello '412 (U.S. Pat. No. 5,696,412 of which is hereby incorporated by reference herein in its entirety) and Ianello '800 (U.S. Pat. No. 5,736,800 of which is hereby incorporated by reference herein in its entirety) allegedly describe a Single Degree of Freedom differential voltage-based method, applicable only to a two pole suspension system, such as a thrust bearing, which uses a coaxial pair of coils. Radial magnetic bearings are commonly constructed as four, six, eight or more poles and commonly include a continuous back iron. These patents fail to consider how to treat flux loop coupling between more than two pole actuators. The described method also has a measurement circuit which cannot avoid the switching noise from the PWM amplifiers.

AMBs require a shaft position sensor in order to determine the control required to maintain the shaft position within the bearing. Typically, electromagnetic coils with magnetic cores are used to generate a magnetic field to adjust the position of the shaft. An aspect of the invention in particular pertains to AMBs which utilize the bearing coils themselves to sense the position of the shaft as well as control the shaft position.

An aspect of the present invention is, but not limited thereto, a differential voltage based method.

None of the patents and patent applications described above provides the important advantages of the invention described herein.

### SUMMARY OF THE INVENTION

An aspect of an embodiment of the present invention to provide improvements to AMBs to sense the position of the rotor using the same coils which are used as actuators to control the position of the rotor.

An aspect of an embodiment of the invention to accurately determine the position of the rotor.

An aspect of an embodiment of the invention to determine the position of the rotor with magnetic bearings having multiple poles.

The above advantages and others not specifically recited are realized through a self sensing integrated system for determining the position of a shaft in a magnetic bearing which includes, but is not limited thereto:
1) An integrated amplifier/self-sensing circuit that acts as a processor,
2) A magnetic bearing,
3) A collocated sensor and magnetic actuator in the form of an electromagnetic coil,
4) A process which coordinates both the sensing function and positioning function of the magnetic coils, with the two functions occurring at different times through time multiplexing.

It should be appreciated that the AMB has a variety of uses. Generally, it can be used in any number of applications that require the use of a bearing. In particular the AMB may have uses which include, but are not limited thereto, the following: ultracentrifuges, high speed gyros and flywheels, turbomachinery, centrifugal compressors, turboexpanders, turbines, machine tool spindles, X-ray tubes, heart pumps, fans, sea water pumps, turbine generators, and circulation pumps. AMBs have general application in many environments and given the advantages of the present invention it may be particularly useful in situations where more reliable, smaller, and lighter weight AMBs are required, such as naval vessels, aircraft, and spacecraft. The present invention may also be useful in healthcare industry or in more rugged environments such as heavy manufacturing settings or oilfields and oilrigs. Another important potential use of this device is as a secondary position sensor placed in an application employing conventional position sensors that have coils wound in the manner required for this invention with the appropriate electronics components included. If a failure of the conventional sensors were to occur, the self sensing device can be activated without requiring physical sensors to be installed. Alternatively, a hybrid system which utilizes a combination of self sensing coils and conventional coils may be used, where failure of the conventional coil system would result in the exclusive use of the self sensing coils and vice versa.

An aspect of an embodiment of the present invention provides an electromagnetic bearing device. The device may comprise: at least one pair of coaxially aligned coils arranged as a stator and forming a center bore; a rotor suspended in the center bore; and a processor connected to the coils for determining the position of the rotor within the center bore and supplying an adjustment signal to adjust the position of the rotor. Additionally, each of the coils may be wound around a core and the processor may operate in at least two time-multiplexed phases. Further, at least one phase may be a sensing phase used to determine the position of the rotor through measuring the inductance of the at least one pair of coils and at least one other phase may be a positioning phase used to supply the adjustment signal to the at least one pair of coils.

An aspect of an embodiment of the present invention provides an electromagnetic bearing device. The device may comprise at least two pairs of coaxially aligned coils arranged as a stator and forming a center bore; a rotor suspended in the center bore; a processor connected to the coils for determining the position of the rotor within the center bore and supplying an adjustment signal to adjust the position of the rotor; a magnet providing a bias flux; and an amplifying circuit which inputs the adjustment signal and outputs a current to the coils. Additionally, each of the coils may be wound around a core, wherein each of the cores is connected through a continuous back iron. Further, the processor may operate in at least two time-multiplexed phases. Still further, at least one phase may be a sensing phase used to determine the position of the rotor through measuring the inductance of the at least one pair of coils and at least one other phase may be a positioning used to supply the adjustment signal to the at least one pair of coils.

An aspect of an embodiment of the present invention provides a method for controlling a magnetic bearing. The method may comprise: sensing the position of a rotor within a magnetic bearing through measuring the inductance in a plurality of electromagnetic coils with a processor; supplying a signal from the processor to the plurality of electromagnetic coils to adjust the position of the rotor; and time-multiplexing the sensing and supplying functions of the processor. Still further, for example, the sensing function may performed by the processor that may be divided into a plurality of phases, each of which involves applying pre-determined voltage patterns to each electromagnetic coil.

The invention itself, together with further objects and attendant advantages, will best be understood by reference to the following detailed description taken with the accompanying drawings and claims.

### BRIEF DESCRIPTION OF THE DRAWINGS

The accompanying drawings, which are incorporated into and form a part of the instant specification, illustrate several aspects and embodiments of the present invention and, together with the description herein, and serve to explain the principles of the invention. The drawings are provided only for the purpose of illustrating select embodiments of the invention and are not to be construed as limiting the invention.

FIG. 1(A) is a cross-sectional schematic view of an active magnetic bearing device.

FIG. 1(B) is an elemental schematic of the processing unit utilized in the invention.

FIG. 1(C) is an elemental schematic of the interface between the sensing and control system and the magnetic bearing.

FIG. 2 is a schematic view of the flux distribution of one of the preferred embodiments of the bearing with a permanent magnet bias.

FIG. 3 is an axial schematic view of the bearing structure.

FIG. 4 is a block diagram of the integrated amplifier structure.

FIG. 5 is a schematic of an exemplary H bridge structure.

FIG. 6 is a partial view of an exemplary time sequence of the signals from the integrated amplifier/self-sensing circuit.

FIG. 7 is a schematic view of a simplified circuit model of a six-pole, permanent magnet biased embodiment of the invention.

FIG. 8 is a schematic view of a simplified circuit model and connection diagram for a coil pair.

FIG. 9 is a cross-sectional schematic view of an active magnetic bearing device with no permanent magnet bias.

FIG. 10 is a schematic view of a typical amplifier structure used with an active magnetic bearing device with no permanent magnet bias.

FIG. 11 is a schematic view of the flux distribution of one of the preferred embodiments.

FIG. 12 is a schematic view of a simplified circuit model of a four-pole, non permanent magnet biased embodiment of the invention.

FIG. 13 is a connection diagram of the coil pairs in a four-pole, non permanent magnet biased embodiment.

### DETAILED DESCRIPTION OF THE INVENTION

An aspect of various embodiments of the present invention can be applied to two types of magnetic bearings. One exemplary embodiment is the permanent magnet (PM) (or other electromagnet) biased magnetic bearing. Another exemplary embodiment is an active magnetic bearing without PM (or other electromagnet) bias. Both exemplary embodiments provide a novel integrated amplifier structure, which is also covered by the present invention.

An embodiment of the present invention comprises a magnetic bearing system and related method that utilizes self-sensing in order to determine and adjust the position of a shaft within the bearing. Magnetic bearings levitate a rotating object with a magnetic field and are unstable in open-loop operation. Position feedback control is required to maintain a rotor in a centered position. Typically, a separate position sensor is used to directly measure the rotor's position for use in this feedback loop. Whereas, the present invention uses a unique design to sense the position of the rotating object with greater accuracy. It comprises coils which are used both to detect and adjust the position of the rotating object and a control system which supplies signals in a time-multiplexed manner in order to determine the position with accuracy while still allowing the same coils that are used to detect position to also supply a field to control the position of the rotor.

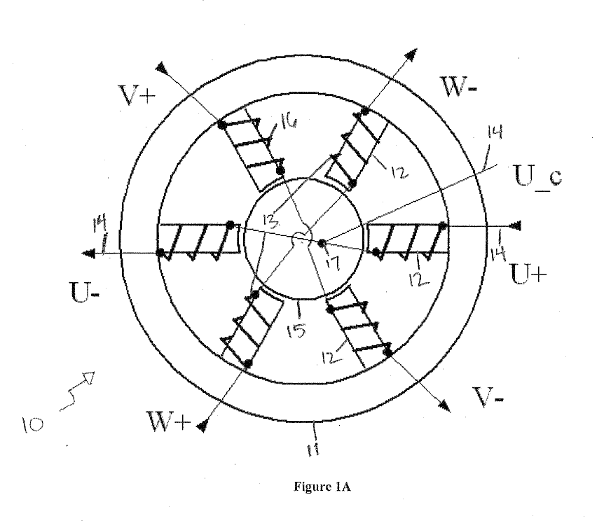

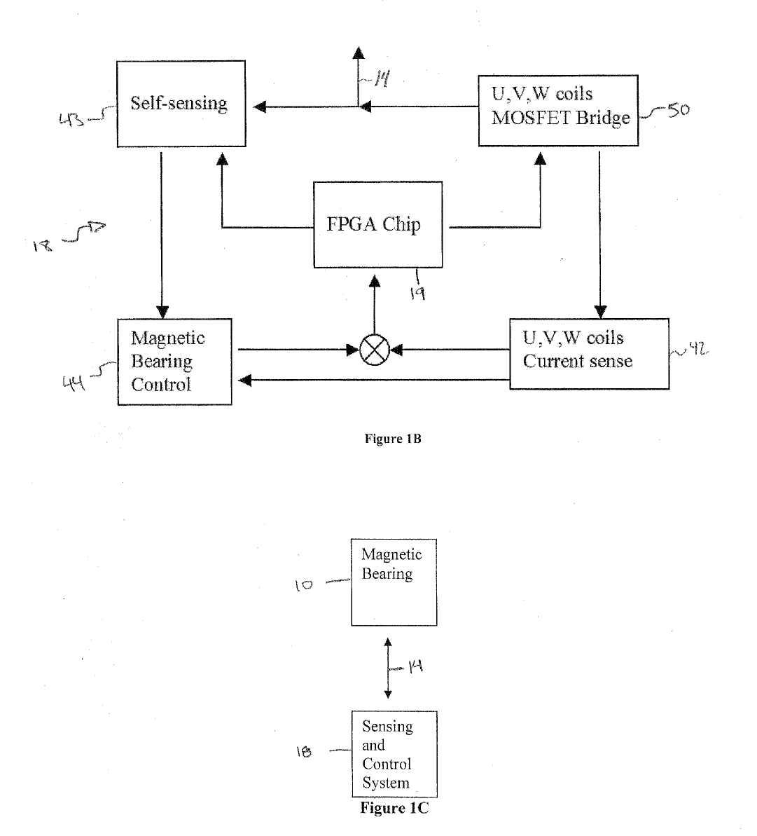

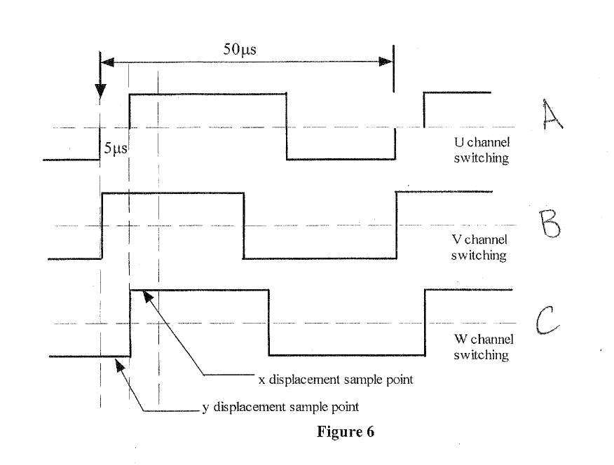

As shown in FIGS. 1(A) and 1(B), in a first embodiment constructed according to the principles of the present invention, an integrated amplifier/self-sensing circuit 18 based on FPGA chips controls the currents of the magnetic coils and the self-sensing sampling circuits, the radial magnet bearing 10 is constructed with a continuous back iron 11 and six poles 12. Other pole numbers (4, 8, etc.) can be constructed based on the same principle. A PM (or electromagnet) provides bias flux axially for the magnetic bearing. The coils on opposite poles of the magnetic bearing are connected to 3 wires 14, connecting to an end of each coil and a common node 17 as seen in FIG. 1(A). The voltage signals are applied to the coils in a time-multiplexed waveform (FIG. 6) controlled by an FPGA 19 (see FIG. 1(B)). First, a small portion of the switching cycles performs the self-sensing. This task is carried out by applying a specific voltage combination to the three pairs of coils. This combination yields both the positions x and y displacement sensed at different time intervals in the switching voltage signal, determined by measuring the voltage difference between the two coils in one opposite pair, resulting in determining the position of the shaft. The process could be repeated for each opposite pair and thus have a fault tolerant position signal generated.

FIG. 1(B) shows the structure of the integrated amplifier/self-sensing circuit structure 18 which is a key to this invention. The FPGA chip 19 has two primary functions: 1) generating the correct voltage combinations at each pair of coils and generating correct sampling gate signals and 2) reading the current feedback comparator logic signal at the second portion of the switching cycle and generating the correct switching signal to a MOSFET H-bridge 50 to maintain the coil current levels given by the magnetic bearing suspension controller. The current sensing 42, the self-sensing 43, and the magnetic bearing control 44 are connected to interact with the FPGA chip 19 as shown. It should be appreciated that a current command(s) may be sent to or from the magnetic bearing control 44 and/or FPGA chip 19, for example. The integrated amplifier/self-sensing circuit is connected to the coil pairs through sets of three wires 14.

FIG. 1(C) is a schematic block diagram of the entire system and shows the interface between the sensing and control system 18 and the magnetic bearing 10. In one embodiment, information from the sensing and control system is sent through sets of three wires 14 that are connected to each coil pair on one end and an output of the FPGA on the other.

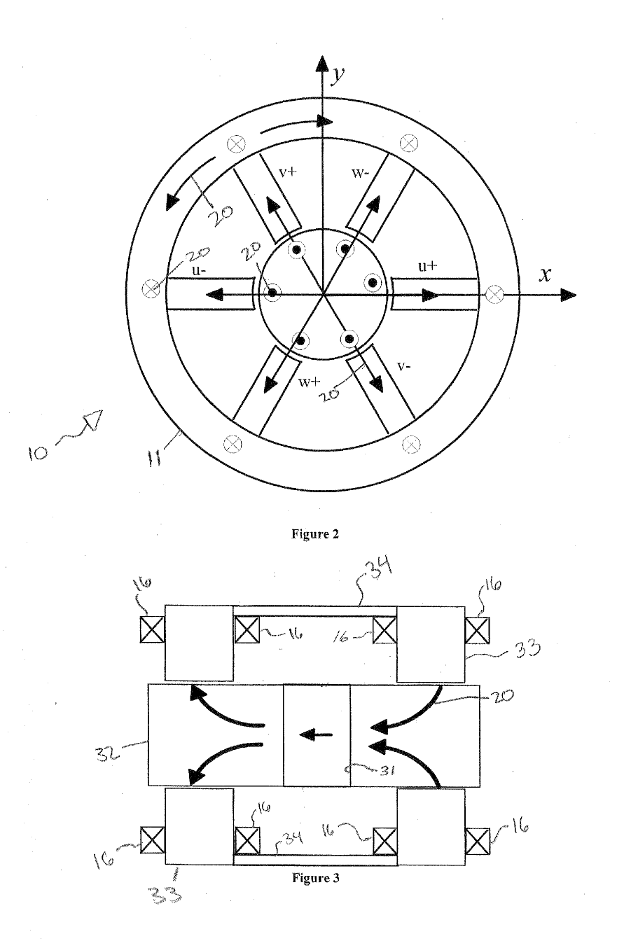

As shown in FIG. 2, the bias flux is conducted axially into the bearing. The arrows 20 show the flux direction in an embodiment which utilizes PM biased magnetic bearings. The coil pairs 13, shown in FIG. 1(A), are connected in such a way that in one side the electromagnetic flux adds to the PM bias flux while on the other side the electromagnetic flux subtracts from the PM bias flux. This process creates the desired magnetic force in the direction of direction of the flux increasing side.

FIG. 3 shows one example of providing axial bias flux with a permanent magnet 31 in the rotor 32. The figure depicts the continuous back irons of two bearings which compose the stator fixture 33 connected through a bias flux linkage 34. The bias flux linkage is composed of a ferromagnetic material to create a magnetic conductive path between the two back irons. The permanent magnet can also be placed in the stator fixture 33.

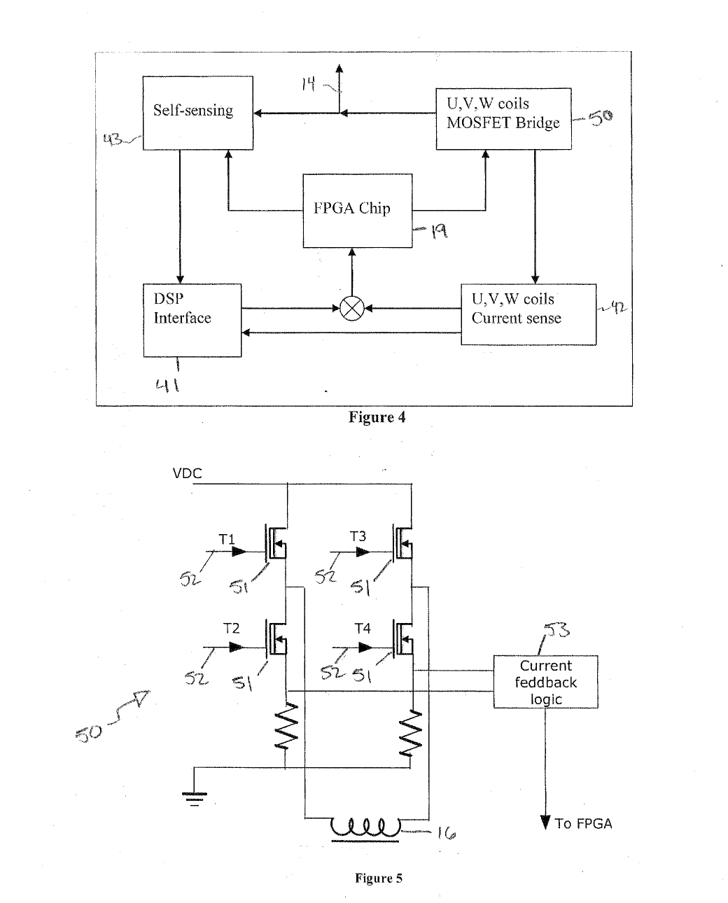

FIG. 4 again shows the structure of the integrated amplifier/self-sensing circuit which is an important aspect to various embodiments of the invention. The FPGA chip 19 again has two functions in this embodiment: generating the correct voltage combinations at each pair of coils and generating correct sampling gate signals and 2) reading the current feedback comparator logic signal at the second portion of the switching cycle and generating the correct switching signal to a MOSFET H-bridge 50 to maintain the coil current levels given by the magnetic bearing controller. The DSP interface 41 can be a standalone chip or its functionality can be included within the FPGA chip 19. The current sensing 42 and self-sensing 43 interact with the coils and the FPGA chip as shown in the figure. It should be appreciated that a current command(s) may be sent to or from the DSP Interface 41 and/or FPGA chip 19, for example. The integrated amplifier/self-sensing circuit is connected to the coil pairs through sets of three wires 14.

FIG. 5 shows the structure of an exemplary MOSFET H-bridge 50 which could be used in the invention. The H-bridge is a common structure used in amplifiers. The novel part of this invention is that the switching commands 52 are generated by proper programming of the FPGA chip and are sent to the individual MOSFETs 51 to perform both current control and self-sensing functions in the proper portion of the switching cycle. The H-bridge also uses current feedback logic 53 to coordinate the desired feedback control of the system.

FIGS. 6(A), 6(B), and 6(C) illustrate the time sequence of the integrated amplifier/self-sensing circuit. Each FIGS. 6(A), 6(B), and 6(C) represent a sample of the control signals being sent on the U, V, and W switching channels, respectively, over the same time period. This sample indicates the novel time-multiplexed strategy to perform both conventional current control and also self-sensing functions of the system. By time-multiplexing, it is meant that the two functions of the bearing voltage/current input signals occur during different time periods in the switching cycle. First, the circuit will perform its sensing function to determine the position of the shaft. During this sensing period, the system does not attempt to control the position of the shaft. The first time period, or sensing phase, may involve applying several different voltage patterns to the coils in order to accurately determine the position of the shaft. As the position of the shaft is been determined, the processor computes the required force to position the shaft appropriately. The required signals to generate that force at the coils are then sent in a second time period, the control phase, during which time no position measurements occur.

FIG. 7 shows a model of a six-pole magnetic bearing. This model utilizes simple circuit elements to allow for the calculation of the position of the shaft within the center bore 15 by using trigonometry, reluctance models, the calculated flux constraint from the bias magnet, and magnetomotive force (MMF) equations. Each coil is represented as a voltage source 71 and the air gap reluctance as a resistor 73, with the orientation of the voltages sources inverted for the individual coils of a corresponding pair. The permanent magnet 72 is represented in the model by a current source. The calculations to determine position are performed using the following theory:

1. Simple reluctance models,

$${R}_{u +} = \frac{{g}_{0}}{{μ}_{0} A} ( 1 - x ) \\ {R}_{u -} = \frac{{g}_{0}}{{μ}_{0} A} ( 1 + x ) \\ {R}_{v +} = \frac{{g}_{0}}{{μ}_{0} A} ( 1 + \frac{x}{2} - \frac{\sqrt{3} y}{2} ) \\ {R}_{v -} = \frac{{g}_{0}}{{μ}_{0} A} ( 1 - \frac{x}{2} + \frac{\sqrt{3} y}{2} ) \\ {R}_{w +} = \frac{{g}_{0}}{{μ}_{0} A} ( 1 + \frac{x}{2} + \frac{\sqrt{3} y}{2} ) \\ {R}_{w -} = \frac{{g}_{0}}{{μ}_{0} A} ( 1 - \frac{x}{2} - \frac{\sqrt{3} y}{2} ) \qquad ( 1 )$$

2. Flux constraint from bias loop:

φᵤ₊+φᵤ₋+φᵥ₊+φᵥ₋+φ_{w+}+φ_{w-}=φ₀ (2)

3. MMF equations:

φᵤ₊Rᵤ₊−NIᵤ=φᵤ₋Rᵤ₋+NIᵤ=φᵥ₊Rᵥ₊−NIᵥ=φᵥ₋Rᵥ₋+NIᵥ=φ_{w+}R_{w+}−NI_{w}=φ_{w-}R_{w-}+NI_{w} (3)

Combining the equations (1) (2) (3) together, we get:

$$[ \begin{matrix}1 - x & - 1 - x & 0 & 0 & 0 & 0 \\ 0 & 1 + x & - 1 - \frac{x}{2} + \frac{\sqrt{3} y}{2} & 0 & 0 & 0 \\ 0 & 0 & 1 + \frac{x}{2} - \frac{\sqrt{3} y}{2} & - 1 + \frac{x}{2} - \frac{\sqrt{3} y}{2} & 0 & 0 \\ 0 & 0 & 0 & 1 - \frac{x}{2} + \frac{\sqrt{3} y}{2} & - 1 - \frac{x}{2} - \frac{\sqrt{3} y}{2} & 0 \\ 0 & 0 & 0 & 0 & 1 + \frac{x}{2} + \frac{\sqrt{3} y}{2} & - 1 + \frac{x}{2} + \frac{\sqrt{3} y}{2} \\ 1 & 1 & 1 & 1 & 1 & 1\end{matrix} ] [ \begin{matrix}{φ}_{u +} \\ {φ}_{u -} \\ {φ}_{v +} \\ {φ}_{v -} \\ {φ}_{w +} \\ {φ}_{w -}\end{matrix} ] = [ \begin{matrix}2 & 0 & 0 \\ - 1 & - 1 & 0 \\ 0 & 2 & 0 \\ 0 & - 1 & - 1 \\ 0 & 0 & 2 \\ 0 & 0 & 0\end{matrix} ] \frac{{μ}_{0} NA}{{g}_{0}} [ \begin{matrix}{I}_{u} \\ {I}_{v} \\ {I}_{w}\end{matrix} ] + [ \begin{matrix}0 \\ 0 \\ 0 \\ 0 \\ 0 \\ {φ}_{0}\end{matrix} ] \qquad ( 4 )$$

Under the assumption that x and y are small numbers, for example x, y<0.1, second order and higher terms can be omitted from the solution, and we then solve the above equations:

$$[ \begin{matrix}{φ}_{u +} - {φ}_{u -} \\ {φ}_{u +} + {φ}_{u -} \\ {φ}_{v +} - {φ}_{v -} \\ {φ}_{v +} + {φ}_{v -} \\ {φ}_{w +} - {φ}_{w -} \\ {φ}_{w +} + {φ}_{w -}\end{matrix} ] = \frac{{μ}_{0} NA}{{g}_{0}} [ \begin{matrix}2 & 0 & 0 \\ \frac{4 x}{3} & \frac{x - \sqrt{3} y}{3} & \frac{x + \sqrt{3} y}{3} \\ 0 & 2 & 0 \\ - \frac{2 x}{3} & \frac{- 2 x + 2 \sqrt{3} y}{3} & \frac{x + \sqrt{3} y}{3} \\ 0 & 0 & 2 \\ - \frac{2 x}{3} & \frac{x - \sqrt{3} y}{3} & \frac{- 2 x - 2 \sqrt{3} y}{3}\end{matrix} ] [ \begin{matrix}{I}_{u} \\ {I}_{v} \\ {I}_{w}\end{matrix} ] + \frac{{φ}_{0}}{6} [ \begin{matrix}2 x \\ 2 \\ - x + \sqrt{3} y \\ 2 \\ - x - \sqrt{3} y \\ 2\end{matrix} ] \qquad ( 5 )$$

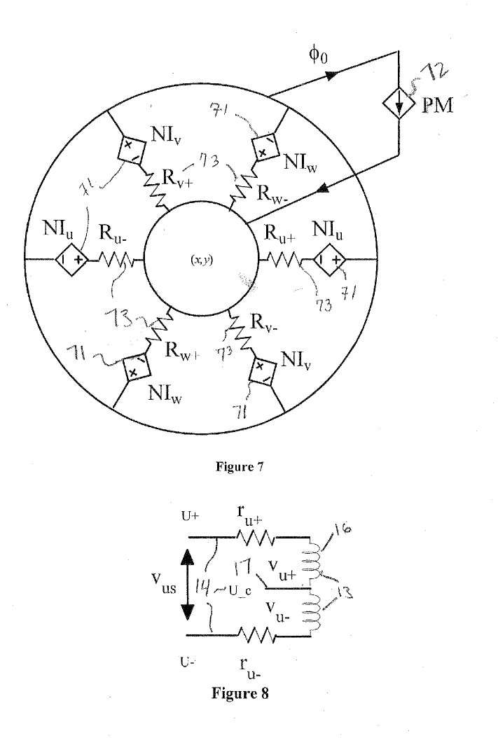

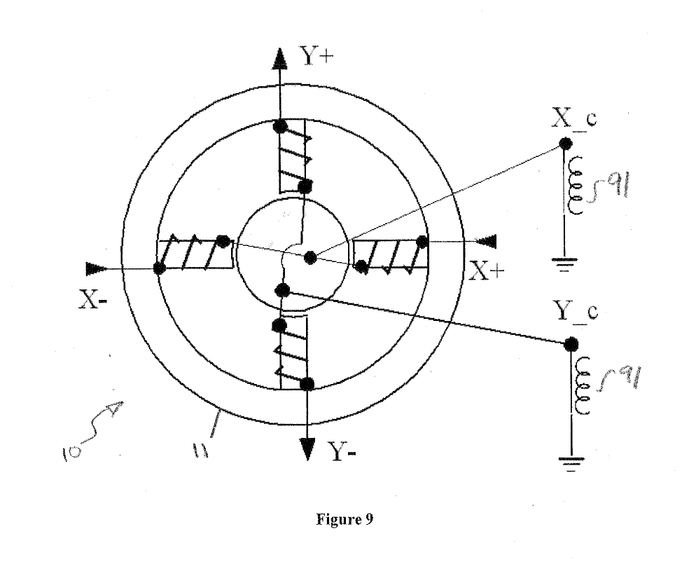

FIG. 8 shows an example of the connection of a pair of coils 13. The set of three wires 14 is connected at one end of each coil and then again at the common node 17. Given those connections we can determine that the voltage generated by the coils is:

$${v}_{u +} = N \frac{d {φ}_{u +}}{d t}$$

$${v}_{u -} = - N \frac{d {φ}_{u -}}{d t}$$

From equations in (5), with the assumption that the shaft positions x, y change relatively slowly compared to the switching frequency, we arrive at:

$$\begin{matrix}\begin{matrix}{v}_{u +} - {v}_{u -} = N \frac{d ( {φ}_{u +} + {φ}_{u -} )}{d t} \\ = \frac{{μ}_{0} {N}^{2} A}{{g}_{0}} ( \frac{4 x}{3} \frac{d {I}_{u}}{d t} + \frac{x - \sqrt{3} y}{3} \frac{d {I}_{v}}{d t} + \frac{x + \sqrt{3} y}{3} \frac{d {I}_{w}}{d t} )\end{matrix} & \\ \begin{matrix}{v}_{us} = {v}_{u +} + {v}_{u -} + ( {r}_{u +} + {r}_{u -} ) {I}_{u} \\ = N \frac{d ( {φ}_{u +} - {φ}_{u -} )}{d t} + ( {r}_{u +} + {r}_{u -} ) {I}_{u} \\ = 2 \frac{{μ}_{0} {N}^{2} A}{{g}_{0}} \frac{d {I}_{u}}{d t} + ( {r}_{u +} + {r}_{u -} ) {I}_{u}\end{matrix} & \\ \frac{d {I}_{u}}{d t} = ( {v}_{us} - ( {r}_{u +} + {r}_{u -} ) {I}_{u} ) \frac{{g}_{0}}{2 {μ}_{0} {N}^{2} A} & \end{matrix}$$

### Then:

$${v}_{u +} - {v}_{u -} = \frac{1}{2} ( \frac{4 x}{3} ( {v}_{us} - ( {r}_{u +} + {r}_{u -} ) {I}_{u} ) + \frac{x - \sqrt{3} y}{3} ( {v}_{vs} - ( {r}_{v +} + {r}_{v -} ) {I}_{v} + \frac{x + \sqrt{3} y}{3} ( {v}_{ws} - ( {r}_{w +} + {r}_{w -} ) {I}_{w} ) )$$

The three channel amplifier in a six-pole circuit will have a waveform shown in FIGS. 6A, 6B, and 6C, that coordinates between the coil pairs to simplify the self-sensing effort, as well as timing its sampling and avoid measurement near the switching noise regions and improve the S/N of displacement signal. That is, through careful timing and programming through the FPGA the voltages will be sampled at times most advantageous for obtaining reliable data, utilizing known patterns of voltage signals that will help to isolate position information from a particular axis.

Therefore, at they displacement sample point, we ignore the resistance terms and determine:

vᵤₛ=0,vᵥₛ=Vₛ,v_{ws}=−Vₛ

Allowing the following result:

$${v}_{u +} - {v}_{u -} = \frac{- \sqrt{3} y}{3} {V}_{s}$$

And at the x displacement sample point we assume:

vᵤₛ=Vₛ,vᵥₛ=Vₛ,v_{ws}=Vₛ,

allowing:

vᵤ₊−vᵤ₋=xVₛ

In a second embodiment, the invention may be constructed according to the principles of the present invention for active magnetic bearings consisting of multiple poles including 4, 6, 8, 10, 12 or any even number of poles (a 4 pole example is shown in FIG. 9). Again the bearing 10 contains a continuous back iron 11 and coil pairs that are connected to the processor. These AMBs do not have a PM bias flux so the coil currents need to be controlled independently. The coils are connected in pairs corresponding to poles in opposite directions (unlike the prior art) with the center of the coil wiring circuit connected to ground via a common inductor 91. The bearing has a NSNS bias flux polarity sequence.

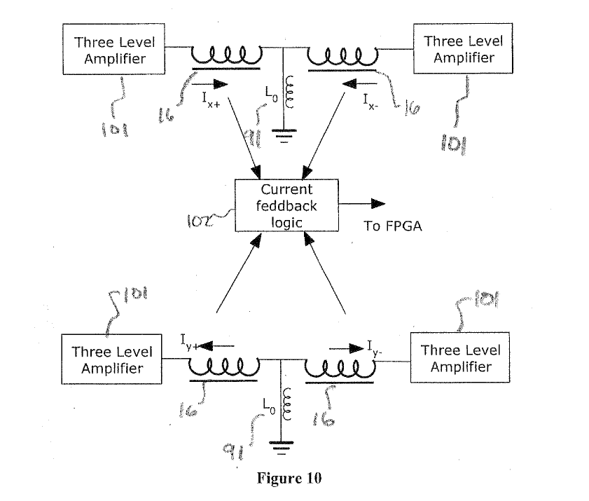

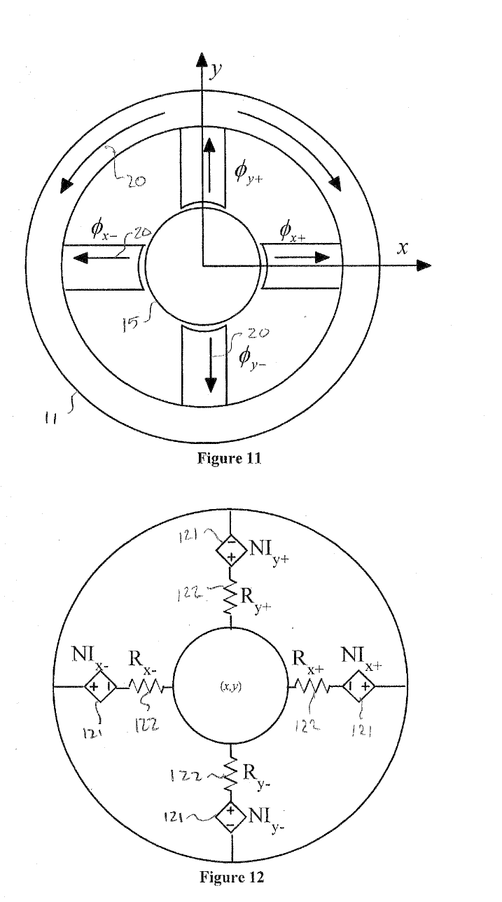

A typical amplifier structure is shown in FIG. 10. The amplifier controls the coil current with a three level voltage amplifier 101. The amplifier is controlled by the FPGA chip to also generate the correct voltage sequence required by self-sensing. As mentioned above, in this embodiment the coils 16 are connected to ground through a common inductor 91. Current information from the coils is processed through current feedback logic 102 and is further processed by the FPGA 19. A model of the magnetic flux is provided in FIG. 11, with field lines 20 again demonstrating the model used to support the equations which help to determine the rotor position. A circuit based model is shown in FIG. 12 with each coil represented by a combination of a voltage source 121 and the air gap resistance as resistor 122.

The position of the shaft within the bearing can be determined using trigonometry, reluctance models, flux constraints and MMF equations:

1. Simple reluctance models,

$${R}_{x +} = \frac{{g}_{0}}{{μ}_{0} A} ( 1 - x ) \\ {R}_{x -} = \frac{{g}_{0}}{{μ}_{0} A} ( 1 + x ) \\ {R}_{y +} = \frac{{g}_{0}}{{μ}_{0} A} ( 1 - y ) \\ {R}_{y -} = \frac{{g}_{0}}{{μ}_{0} A} ( 1 + y ) \qquad ( 6 )$$

2. Flux constraint:

φₓ₊+φₓ₋+φ_{y+}+φ_{y-}=0 (7)

3 MMF equations:

φₓ₊Rₓ₊−NIₓ₊=φₓ₋Rₓ₋−NIₓ₋=φ_{y+}R_{y+}+NI_{y+}=φ_{y-}R_{y-}+NI_{y-} (8)

Putting equations (6) (7) (8) together, we get:

$$[ \begin{matrix}1 - x & - 1 - x & 0 & 0 \\ 0 & 1 + x & - 1 + y & 0 \\ 0 & 0 & 1 - y & - 1 - y \\ 1 & 1 & 1 & 1\end{matrix} ] [ \begin{matrix}{φ}_{x +} \\ {φ}_{x -} \\ {φ}_{y +} \\ {φ}_{y -}\end{matrix} ] = [ \begin{matrix}1 & - 1 & 0 & 0 \\ 0 & 1 & 1 & 0 \\ 0 & 0 & - 1 & 1 \\ 0 & 0 & 0 & 0\end{matrix} ] \frac{{μ}_{0} NA}{{g}_{0}} [ \begin{matrix}{I}_{x +} \\ {I}_{x -} \\ {I}_{y +} \\ {I}_{y -}\end{matrix} ] \qquad ( 9 )$$

In order to solve the above equations, we assume that x, y are small numbers, for example x, y<0.1, and therefore the second order terms can be dropped from the solution with the result:

$$[ \begin{matrix}{φ}_{x +} \\ {φ}_{x -} \\ {φ}_{y +} \\ {φ}_{y -}\end{matrix} ] = \frac{{μ}_{0} NA}{{g}_{0}} [ \begin{matrix}\frac{3 + 2 x}{4} & - \frac{1}{4} & \frac{1 + x + y}{4} & \frac{1 + x - y}{4} \\ - \frac{1}{4} & \frac{3 - 2 x}{4} & \frac{1 - x + y}{4} & \frac{1 - x - y}{4} \\ \frac{- 1 - x - y}{4} & \frac{- 1 + x - y}{4} & - \frac{3 + 2 y}{4} & \frac{1}{4} \\ \frac{- 1 - x + y}{4} & \frac{- 1 + x + y}{4} & \frac{1}{4} & - \frac{3 - 2 y}{4}\end{matrix} ] [ \begin{matrix}{I}_{x +} \\ {I}_{x -} \\ {I}_{y +} \\ {I}_{y -}\end{matrix} ]$$

Then, the variables are reorganized such that:

$$[ \begin{matrix}{φ}_{x +} - {φ}_{x -} \\ {φ}_{x +} + {φ}_{x -} \\ {φ}_{y +} - {φ}_{y -} \\ {φ}_{y +} + {φ}_{y -}\end{matrix} ] = \frac{{μ}_{0} NA}{{g}_{0}} [ \begin{matrix}1 & \frac{x}{2} & 0 & \frac{x}{2} \\ \frac{x}{2} & \frac{1}{2} & \frac{y}{2} & \frac{1}{2} \\ 0 & - \frac{y}{2} & - 1 & - \frac{y}{2} \\ - \frac{x}{2} & - \frac{1}{2} & - \frac{y}{2} & - \frac{1}{2}\end{matrix} ] [ \begin{matrix}{I}_{x +} - {I}_{x -} \\ {I}_{x +} + {I}_{x -} \\ {I}_{y +} - {I}_{y -} \\ {I}_{y +} + {I}_{y -}\end{matrix} ] \qquad ( 10 )$$

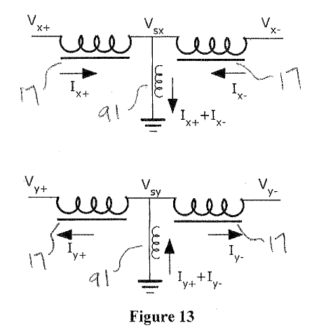

FIG. 13 shows the connection diagram to each of the coils 17 and the common inductor 91. Based on the connection of the coils seen in the figure, the voltage generated by the coils is:

$${v}_{x +} - {v}_{sx} = N \frac{d {φ}_{x +}}{d t} + {I}_{x +} R$$

$${v}_{x -} - {v}_{sx} = N \frac{d {φ}_{x -}}{d t} + {I}_{x -} R$$

$${v}_{sx} = {L}_{0} \frac{d ( {I}_{x +} + {I}_{x -} )}{d t} \\ - {v}_{y +} + {v}_{sy} = - N \frac{d {φ}_{y +}}{d t} + {I}_{y +} R \\ - {v}_{y -} + {v}_{sy} = - N \frac{d {φ}_{y -}}{d t} + {I}_{y -} R \\ - {v}_{sy} = {L}_{0} \frac{d ( {I}_{y +} + {I}_{y -} )}{d t}$$

So, under the assumption again that x, y change relatively slowly and using the formula

$$\begin{matrix}{L}_{M} = \frac{{μ}_{0} {N}^{2} A}{{g}_{0}} \\ Then \\ \begin{matrix}{v}_{x +} - {v}_{x -} = N \frac{d ( {φ}_{x +} - {φ}_{x -} )}{d t} + ( {I}_{x +} - {I}_{x -} ) R \\ = {L}_{M} ( \frac{d ( {I}_{x +} - {I}_{x -} )}{d t} + \frac{x}{2 {L}_{0}} ( {v}_{sx} - {v}_{sy} ) ) + ( {I}_{x +} - {I}_{x -} ) R\end{matrix} & ( 11 ) \\ \begin{matrix}{v}_{x +} + {v}_{x -} - 2 {v}_{sx} = N \frac{d ( {φ}_{x +} + {φ}_{x -} )}{d t} + ( {I}_{x +} + {I}_{x -} ) R \\ = {L}_{M} ( \begin{matrix}\frac{x}{2} \frac{d ( {I}_{x +} - {I}_{x -} )}{d t} + \frac{y}{2} \frac{d ( {I}_{y +} - {I}_{y -} )}{d t} + \\ \frac{1}{2 {L}_{0}} ( {v}_{sx} - {v}_{sy} )\end{matrix} ) + \\ ( {I}_{x +} + {I}_{x -} ) R\end{matrix} & \end{matrix}$$

The same analysis for y direction equations yields:

$$\begin{matrix}\begin{matrix}{v}_{y +} - {v}_{y -} = N \frac{d ( {φ}_{y +} - {φ}_{y -} )}{d t} - ( {I}_{y +} - {I}_{y -} ) R \\ = {L}_{M} ( - \frac{d ( {I}_{y +} - {I}_{y -} )}{d t} - \frac{y}{2 {L}_{0}} ( {v}_{sx} - {v}_{sy} ) ) - ( {I}_{y +} - {I}_{y -} ) R\end{matrix} & \\ \begin{matrix}{v}_{y +} + {v}_{y -} - 2 {v}_{sy} = N \frac{d ( {φ}_{y +} + {φ}_{y -} )}{d t} - ( {I}_{y +} + {I}_{y -} ) R \\ = {L}_{M} ( \begin{matrix}- \frac{x}{2} \frac{d ( {I}_{x +} - {I}_{x -} )}{d t} - \frac{y}{2} \frac{d ( {I}_{y +} - {I}_{y -} )}{d t} - \\ \frac{1}{2 {L}_{0}} ( {v}_{sx} - {v}_{sy} )\end{matrix} ) - \\ ( {I}_{y +} + {I}_{y -} ) R\end{matrix} & \end{matrix}$$

From the equation in (10).
Then, using the FPGA to apply the voltage combinations of:

vₓ₊=0vₓ₋=0v_{y+}=−V_{DC}v_{y-}=V_{DC}

### Then:

$$\frac{d ( {I}_{x +} - {I}_{x -} )}{d t} \approx 0$$

$$\frac{d ( {I}_{y +} - {I}_{y -} )}{d t} \approx \frac{2 {V}_{DC}}{{L}_{M}}$$

$${I}_{x +} + {I}_{x -} \approx 2 {I}_{0} ( bias\_current )$$

So from the second equation in (11)

$$y = \frac{- 2 {v}_{sx} - 2 {I}_{0} R - {L}_{M} ( {v}_{sx} - {v}_{sy} ) / 2 {L}_{0}}{{V}_{DC}}$$

Again, using the FPGA or other processor, we apply the voltage combination of:

vₓ₊=V_{DC}vₓ₋=−V_{DC}v_{y+}=0v_{y-}=0

And by the same way we arrive at:

$$x = \frac{- 2 {v}_{sx} - 2 {I}_{0} R - {L}_{M} ( {v}_{sx} - {v}_{sy} ) / 2 {L}_{0}}{{V}_{DC}}$$

The following patents, applications and publications as listed below and throughout this document are hereby incorporated by reference in their entirety herein.

The devices, systems, compositions and methods of various embodiments of the invention disclosed herein may utilize aspects disclosed in the following references, applications, publications and patents and which are hereby incorporated by reference herein in their entirety:

U.S. Pat. No. 6,664,680,

U.S. Pat. No. 7,215,054,

U.S. Pat. No. 7,252,001,

U.S. Pat. No. 7,302,762, and

M. E. F. Kasarda, “An Overview of Active Magnetic Bearing Technology and Applications” The Shock and Vibration Digest 2000; Vol. 32, No. 2, 91-99 2000.

Of course, it should be understood that a wide range of changes and modifications can be made to the preferred embodiment described above. It is therefore intended that the foregoing detailed description be understood that it is the following claims, including all equivalents, which are intended to define the scope of this invention.

Unless clearly specified to the contrary, there is no requirement for any particular described or illustrated activity or element, any particular sequence or such activities, any particular size, speed, material, duration, contour, dimension or frequency, or any particularly interrelationship of such elements. Moreover, any activity can be repeated, any activity can be performed by multiple entities, and/or any element can be duplicated. Further, any activity or element can be excluded, the sequence of activities can vary, and/or the interrelationship of elements can vary. It should be appreciated that aspects of the present invention may have a variety of sizes, contours, shapes, compositions and materials as desired or required.

In summary, while the present invention has been described with respect to specific embodiments, many modifications, variations, alterations, substitutions, and equivalents will be apparent to those skilled in the art. The present invention is not to be limited in scope by the specific embodiment described herein. Indeed, various modifications of the present invention, in addition to those described herein, will be apparent to those of skill in the art from the foregoing description and accompanying drawings. Accordingly, the invention is to be considered as limited only by the spirit and scope of the following claims, including all modifications and equivalents.

Still other embodiments will become readily apparent to those skilled in this art from reading the above-recited detailed description and drawings of certain exemplary embodiments. It should be understood that numerous variations, modifications, and additional embodiments are possible, and accordingly, all such variations, modifications, and embodiments are to be regarded as being within the spirit and scope of this application. For example, regardless of the content of any portion (e.g., title, field, background, summary, abstract, drawing figure, etc.) of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated. Further, any activity or element can be excluded, the sequence of activities can vary, and/or the interrelationship of elements can vary. Unless clearly specified to the contrary, there is no requirement for any particular described or illustrated activity or element, any particular sequence or such activities, any particular size, speed, material, dimension or frequency, or any particularly interrelationship of such elements. Accordingly, the descriptions and drawings are to be regarded as illustrative in nature, and not as restrictive. Moreover, when any number or range is described herein, unless clearly stated otherwise, that number or range is approximate. When any range is described herein, unless clearly stated otherwise, that range includes all values therein and all sub ranges therein. Any information in any material (e.g., a United States/foreign patent, United States/foreign patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such incorporated by reference material is specifically not incorporated by reference herein.

What is claimed is:

1. An electromagnetic bearing device, comprising:
at least one pair of coaxially aligned coils arranged as a stator and forming a center bore;
a rotor suspended in said center bore;
a processor connected to said coils for determining the position of said rotor within said center bore and supplying an adjustment signal to adjust said position of said rotor;
wherein each of said coils are wound around a core;
wherein said processor operates in at least two time-multiplexed phases; and
wherein at least one phase is a sensing phase used to determine the position of said rotor through measuring the inductance of said at least one pair of coils and at least one other phase is a positioning phase used to supply said adjustment signal to said at least one pair of coils.

2. The device of claim 1, further comprising a plurality of said coil pairs,
wherein each of said plurality of coil pairs are spaced from one another,
wherein said spacing may be equal, unequal, or some combination of equal and unequal.

3. The device of claim 1, further comprising:
an amplifying circuit which inputs said adjustment signal and outputs a control current to said at least one pair of coils.

4. The device of claim 3, wherein said adjustment signal is a voltage supplied by said processor.

5. The device of claim 4, wherein said amplifying circuit is a MOSFET H-bridge or similar amplifying circuit.

6. The device of claim 3, wherein said amplifying circuit is another amplifier design that prevents switching transient voltages from interfering with the measurement signals.

7. The device of claim 1, further comprising a continuous back iron, wherein each of said cores are connected to said continuous back iron.

8. The device of claim 1, further comprising a permanent magnet arranged in said rotor, wherein said permanent magnet supplies a bias flux.

9. The device of claim 1, further comprising an electromagnet arranged in said stator, wherein said electromagnet supplies a bias flux.

10. The device of claim 1, further comprising a permanent magnet arranged in said stator, wherein said permanent magnet supplies a bias flux.

11. The device of claim 1, wherein said processor is a digital computing device.

12. The device of claim 11, wherein said digital computing device is a DSP.

13. The device of claim 11, wherein said digital computing device is an FPGA.

14. The device of claim 1, wherein said processor is an ASIC.

15. The device of claim 1, wherein said processor is a combination of computing devices such as DSPs, FPGAs, ASICs, or analog circuits.

16. The device of claim 1, wherein said sensing phase is further comprised of:
a series of predetermined combinations of voltages to each pair of coils applied sequentially to sense the position of said rotor relative to each pair of coils.

17. The device of claim 16, further comprising:
a set of three wires for each coil pair; wherein one wire is connected to one coil,
a second wire is connected to the corresponding paired coil, and
a third wire is connected to a common ground node shared by said paired coils.

18. The device of claim 1 wherein said device can be implemented in any one or more of the following systems: ultracentrifuges, high speed gyros and flywheels, turbomachinery, centrifugal compressors, turboexpanders, turbines, machine tool spindles, X-ray tubes, heart pumps, fans, sea water pumps, turbine generators, and circulation pumps.

19. An electromagnetic bearing device, comprising:
at least two pairs of coaxially aligned coils arranged as a stator and forming a center bore;
a rotor suspended in said center bore;
a processor connected to said coils for determining the position of said rotor within said center bore and supplying an adjustment signal to adjust said position of said rotor;
a magnet providing a bias flux;
an amplifying circuit which inputs said adjustment signal and outputs a current to said coils;
wherein each of said coils are wound around a core;
wherein each of said cores are connected through a continuous back iron;
wherein said processor operates in at least two time-multiplexed phases; and
wherein at least one phase is a sensing phase used to determine the position of said rotor through measuring the inductance of said at least one pair of coils and at least one other phase is a positioning used to supply said adjustment signal to said at least one pair of coils.

20. The device of claim 19, wherein said magnet is an electromagnet arranged in said stator.

21. The device of claim 19, wherein said magnet is a permanent magnet arranged in said stator.

22. The device of claim 19, wherein said magnet is a permanent magnet arranged in said rotor.

23. The device of claim 19, wherein said processor is a DSP.

24. The device of claim 19, wherein said processor is an FPGA.

25. The device of claim 19, wherein said processor is an ASIC.

26. The device of claim 19, wherein said processor is an analog circuit.

27. The device of claim 19, wherein said processor is some combination of computing devices such as DSPs, FPGAs, ASICs, other digital devices, or analog circuits.

28. The device of claim 19, wherein said amplifying circuit is a MOSFET H-bridge.

29. The device of claim 19, wherein said amplifying circuit is a circuit which inputs said adjustment signal as a voltage.

30. The device of claim 19, wherein said sensing phase is further comprised of:
a series of predetermined combinations of voltages to each pair of coils applied sequentially to sense the position of said rotor relative to each pair of coils.

31. The device of claim 30, further comprising:
a set of three wires for each coil pair; wherein one wire is connected to one coil, a second wire is connected to the corresponding paired coil, and a third wire is connected to a common ground node shared by said paired coils.

32. The device of claim 19 wherein said device can be implemented in any one or more of the following systems: ultracentrifuges, high speed gyros and flywheels, turbomachinery, centrifugal compressors, turboexpanders, turbines, machine tool spindles, X-ray tubes, heart pumps, fans, sea water pumps, turbine generators, and circulation pumps.

33. A method for controlling a magnetic bearing comprising:
sensing the position of a rotor within a magnetic bearing through measuring the inductance in a plurality of electromagnetic coils with a processor;
supplying a signal from said processor to said plurality of electromagnetic coils to adjust the position of said rotor; and
time-multiplexing said sensing and supplying functions of said processor.

34. The method of claim 33, wherein said sensing function performed by said processor is divided into a plurality of phases, each of which involves applying pre-determined voltage patterns to each electromagnetic coil.

35. The method of claim 33, further comprising amplifying said signal that is supplied by the processor.

36. The method of claim 33 wherein said method can be implemented in any one or more of the following systems: ultracentrifuges, high speed gyros and flywheels, turbomachinery, centrifugal compressors, turboexpanders, turbines, machine tool spindles, X-ray tubes, heart pumps, fans, sea water pumps, turbine generators, and circulation pumps.
